(19) United States
(12) Patent Application Publication
(10) Pub. No.: US 2025/0365222 A1
(43) Pub. Date: Nov. 27, 2025

(54) TROUBLESHOOTING FOR 5G WIRELESS NETWORK

(71) Applicant: DISH Wireless L.L.C., Englewood, CO (US)

(72) Inventor: Mahdi Khansari, Englewood, CO (US)

(73) Assignee: DISH Wireless L.L.C., Englewood, CO (US)

(21) Appl. No.: 19/216,280

(22) Filed: May 22, 2025

Related U.S. Application Data
(60) Provisional application No. 63/650,808, filed on May 22, 2024.

(51) Int. Cl. H04L 41/5009; H04L 41/16; H04L 43/06

(52) U.S. Cl. CPC H04L 41/5009; H04L 41/16; H04L 43/06

(57) ABSTRACT

Systems and automated processes are described to provide collection of wireless network status data, such as a 5G network, and to automatically respond to queries regarding the performance of the network. Systems and automated processes may, in response to a request for network performance information, obtain performance and static data from network data sources, analyze the static data to generate validated site data, apply a KPI formula to the performance data to generate KPI data, and generate a network performance report based on the validated site data and KPI data. In addition, the systems and automated processes may use an appropriate machine learning model from a library of models to determine recommended actions to increase network performance and may automatically implement such actions. A top offender system may be implemented to analyze the status data to determine the network elements having the largest negative impact on network performance.

### CROSS-REFERENCE TO RELATED APPLICATIONS

The following application claims the benefit of U.S. Provisional Patent Application No. 63/650,808 filed on May 22, 2024 and entitled “TROUBLESHOOTING FOR 5G WIRELESS NETWORK,” which is incorporated herein by reference.

### TECHNICAL FIELD

The following generally relates to wireless data networks, such as 5G wireless networks. More particularly, the following relates to systems, devices, and automated processes to monitor network status data and provide summaries and recommendations to improve network performance.

### BACKGROUND

Wireless networks that transport digital data and telephone calls are becoming increasingly sophisticated. Currently, fifth generation (“5G”) broadband cellular networks are being deployed around the world. These 5G networks use emerging technologies to support data and voice communications with millions, if not billions, of mobile phones, computers, and other devices. 5G technologies are capable of supplying much greater bandwidth than was previously available, so it is likely that the widespread deployment of 5G networks could radically expand the number of services available to customers.

Traditionally, data and telephone networks relied upon proprietary designs based upon very specialized hardware and dedicated point-to-point data connections. More recently, industry standards such as the Open Radio Access Network (“Open RAN” or “O-RAN”) standard have been developed to describe interactions between the network and various client devices. The O-RAN model follows a virtualized wireless architecture in which 5G base stations (“gNBs”) are implemented using separate centralized units (CUs), distributed units (DUs) and radio units (RUs), along with various control planes that provide additional network functions (e.g., 5G Core, IMS, OSS/BSS/IT). Generally speaking, it is still necessary to implement the RUs with physical transmitters, antennas, routers, and other hardware located onsite within broadcast range of the end user's device.

Other components of the network, however, can be implemented using a more centralized architecture based upon cloud-based computing resources, such as those available from Amazon Web Services (AWS) or the like. This provides much better network management, scalability, reliability and redundancy, as well as other benefits. O-RAN CUs, DUs, control planes and/or other components of the network can now be implemented as software modules executed by distributed (e.g., “cloud”) computing hardware. Other network functions such as access control, message routing, security, billing and the like can similarly be implemented using centralized cloud computing resources. Often, a CU, DU, control plane or other image is created in software for execution by one or more virtual computers operating in parallel within the cloud environment. The many virtual servers can be very rapidly scaled to increase or decrease the available computing capacity as needed.

The use of virtualized hardware provides numerous benefits in terms of rapid deployment and scalability, but it also presents certain technical challenges that have not been encountered in more traditional wireless networks. Unlike traditional wireless networks that scaled through the addition of physical routers, switches, and other hardware, RAN networks can scale upwardly and downwardly very quickly as new cloud-based services are deployed and/or existing services are retired or redeployed. Additional network components can be very quickly deployed, for example, through the use of virtual components executing in a cloud environment that can be very quickly duplicated and spawned as needed to support increased demand. Similarly, virtual components can be de-commissioned very quickly with very little cost or effort when network capacity allows. The virtual components provide substantial efficiencies, especially when compared to prior networks that were based upon complex interconnections between geographically dispersed routers, servers and the like.

The flexibility and rapid variability of such networks leads to a large (but possibly constantly changing) amount of available status data corresponding to the operation of the various network components, the network as a whole, and the like. Maintaining an up-to-date summary of network status becomes difficult with the amount of available data and its changeability. Given the complexity of such networks, performance reports can rapidly become out of date or otherwise inaccurate, leading to missed opportunities to correct network behavior, quickly fix cell site issues, and the like. In addition, such networks may be maintained by a variety of organizations (e.g., different functional groups within a company) and each organization may have its own performance goals, troubleshooting processes/requirements, and the like, making one-size-fits-all performance reports ineffective in many cases. Further, the highly scalable nature of such networks can mask (or otherwise make difficult to detect) emergent performance issues. High availability is required for each cell site and the network to minimize data and voice service interruptions, so it is desirable to provide improved customizable troubleshooting information to facilitate improvement and optimization of network performance.

One technical challenge that arises in the new networks, therefore, involves monitoring the status, performance, and connectivity of the networks. Network components can be commissioned and de-commissioned very rapidly, and conditions can evolve very quickly in various parts of the network. Tracking the performance, status, and connectivity of a large-scale RAN network can therefore be very difficult due to the scale of resources involved and the dynamic nature of such networks. A substantial desire therefore exists to build systems, devices, and automated processes that allow for improved monitoring and troubleshooting of emerging 5G wireless networks. These and other features are described in increasing detail below.

### BRIEF SUMMARY

Various embodiments relate to systems, devices, and automated processes to provide status data management and provide reports of obtained status data, for example in response to a user query, automated query, and the like. According to various embodiments, systems and automated processes may automatically collect various status data from the network and its components, process it using one or more subsystems to validate and determine various aspects of network performance, and determine a variety of performance reports based on user queries from individual users, automated processes, or the like. The systems and automated processes may provide dashboards, reports, alerts, notifications, top offender lists, or other information about the performance of the network, including the various network elements.

In various embodiments, a performance analysis system is provided having a processor and an interface to a wireless network having a plurality of cell sites, the performance analysis system comprising: a user interface configured to receive a user request for a network performance report; a data management subsystem configured to obtain, via the network interface and from one or more network data sources, a performance data and a static data, wherein the data management subsystem comprises: a site subsystem configured to analyze, using the processor, the obtained static data to generate a validated site data; and a key performance indicator (KPI) subsystem configured to apply, using the processor, a KPI formula to the obtained performance data to generate a KPI data. The performance analysis system may further comprise a reporting subsystem configured to: generate, by the processor and according to the received user request, the network performance report based on the validated site data and the KPI data; and provide, via the user interface, the generated network performance report.

Still other embodiments provide an automated process performed by a performance analysis system associated with a wireless network having a plurality of cell sites, the performance analysis system comprising a processor and an interface to the wireless network, the automated process comprising: receiving a user request for a network performance report via a user interface of the performance analysis system; obtaining, by a data management subsystem of the performance analysis system, a performance data and a static data from one or more network data sources via the network interface; analyzing, by a site subsystem of the data management subsystem, the obtained static data to generate a validated site data; applying, by a key performance indicator (KPI) subsystem of the data management subsystem, a KPI formula to the obtained performance data to generate a KPI data; obtaining, by a reporting subsystem and from the site subsystem, the validated site data in response to the user request; obtaining, by the reporting subsystem and from the KPI subsystem, the KPI data in response to the user request; and generating, by the reporting subsystem, the network performance report based on the obtained validated site data and obtained KPI data.

These and other example embodiments are described in increasing detail below.

### BRIEF DESCRIPTION OF DRAWING FIGURES

FIG. 1 shows an example of a 5G wireless network that is implemented with a cloud-based computing system.

FIG. 2 is a block diagram of an exemplary performance analysis system, according to various embodiments.

FIG. 3 is a diagrammatic representation of network hierarchy levels, according to various embodiments.

FIG. 4 is a process flow diagram illustrating an example of a static data validation process, according to various embodiments.

FIG. 5 is a flow diagram illustrating an example of an automated process to determine KPI data, according to various embodiments.

FIG. 6 is a process flow diagram illustrating an example of a top offender determination process, according to various embodiments.

FIG. 7 illustrates an exemplary top offender output report, according to various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, a performance analysis system obtains operating or other performance data relating to the various modules of a RAN-based mobile network system. The data management system can be configured to receive streaming data that may be available from one or more data sources. Alternately and/or additionally, the performance analysis system can place queries to other sources of data. Data received via query and/or streams can be filtered, formatted, tagged with metadata and/or otherwise processed into a format suitable for processing by the performance analysis system, including its subsystems. The performance analysis system may process the received data using one or more subsystems, including in some cases machine learning models, and may store the processed and unprocessed data for later use. The performance analysis system, including its subsystems, may access the stored data in response to a query (by a user, automated, scheduled, triggered, etc.), for example using one or more subsystems to summarize the data in response to the query. The performance analysis system may additionally create a dashboard or other reports for evaluation by humans and/or by other automated processes based upon the processed data, may additionally determine and/or automatically implement recommended changes to the network, and the like.

Using a performance analysis system to obtain and analyze the massive amount of information produced by a cloud-based 5G wireless network accordingly allows for real time (or near real-time, accounting for some delays inherent in processing, data communications and the like) monitoring, troubleshooting, and control of a 5G wireless network in a manner that was not previously thought to be possible. The use of a performance analysis system also provides for rapid optimization and adaptation to dynamic cloud-based systems, providing a variety of accurate performance summaries customized for particular troubleshooting needs, along with appropriate recommendations, thus providing faster responses to network and performance changes and thereby allowing increased efficiency and a reduction in operating costs of the network.

Use of the automated processes and systems described herein allows for detailed, configurable, customizable, and interactive reports corresponding to network-related performance and troubleshooting in a manner not previously possible. The use of the systems and methods allows deeper insights into the network and cell site status, for a more complete and accurate view and efficient identification, analysis, and correction of issues in the network. The systems and methods described herein result in higher network uptime and facilitate meeting quality of service and other goals.

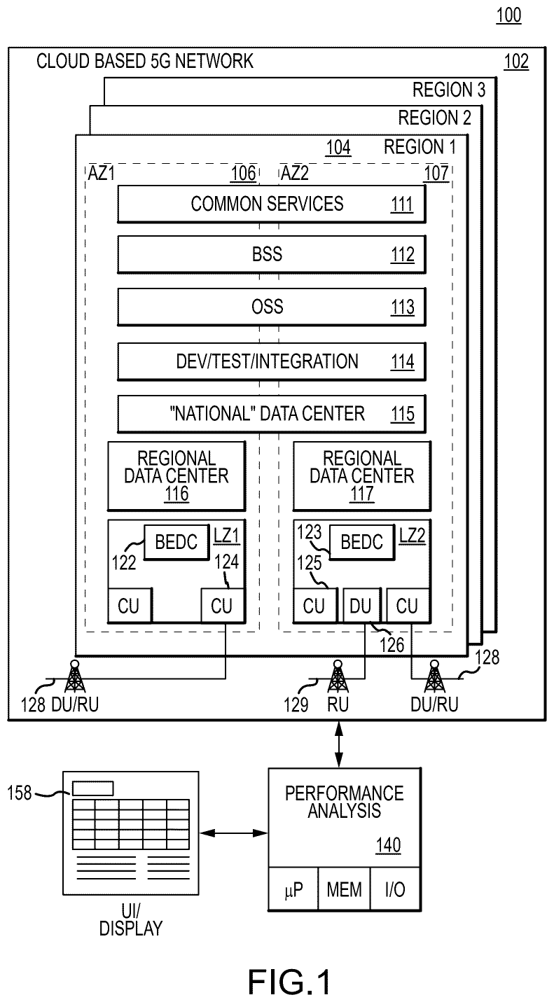

With reference to FIG. 1, a 5G wireless network 102 can be implemented using cloud-based computing resources, such as those available from Amazon Web Services Inc. (AWS) of Seattle, Washington. Other cloud services are available from Microsoft Corp. of Redmond, Washington, IBM Corp. of Armonk, New York, and others. In the example of FIG. 1, network 102 encompasses data processing services supporting multiple regions 104, each having one or more availability zones (AZs) 106, 107 each acting as a separate data center with its own redundant power, network connectivity and other resources as desired. In some implementations, the various AZs operating within the same region will provide redundancy in the event that another AZ would fail, become overloaded, or otherwise become unavailable.

The example of FIG. 1 illustrates three regions, with region 104 having two AZs 106, 107, although other embodiments could include any number of regions and AZs providing any number of services and resources. The regions, markets, zones, and the like are often described herein with reference to geographic locations, but in practice could be equivalently organized based upon customer density, user density, expected network demand, availability of electric power and/or bandwidth, reorganized based on demand, availability, etc., and/or any other factors. As noted above, it will still be necessary to deploy radio units (RUs) within broadcast range of end users. By implementing the other functions of the network using virtualized hardware operating within a cloud-type architecture, geographic restrictions upon the network 102 can be greatly reduced. This can provide substantial efficiencies in deployment and expansion of network 102, while also allowing for more efficient use of computing resources, data storage and electric power. However, particular arrangements, operational parameters, and performance requirements of each cell site and the various components of the network 102 might be required to support such efficiencies. Performance analysis systems and methods as described herein can facilitate meeting and maintaining appropriate network performance.

In example system 100, a network operator maintains ownership of one or more radio units (RUs) located at wireless network cell sites 128, 129. Each RU suitably communicates with user equipment (UE) operating within a geographic area of its respective cell site using one or more antennas/towers capable of transmitting and receiving messages within an assigned spectrum of electromagnetic bandwidth (which may also be referred to herein as a “spectrum band” or “frequency band”). In various embodiments, the assigned spectrum may be allocated across one or more guest networks to support multiple concurrent networks, if desired.

The Open RAN standard breaks communications into three main domains: the radio unit (RU) that handles radio frequency (RF) and lower physical layer functions of the radio protocol stack, including beamforming; the distributed unit (DU) that handles higher physical access layer, media access (MAC) layer and radio link control (RLC) functions; and the centralized unit (CU) that performs higher level functions, including quality of service (QOS) routing and the like. The CU also supports packet data convergence protocol (PDCP), service data adaptation protocol (SDAP) and radio resource controller (RRC) functions. The RU, DU and CU functions are described in more detail in the Open RAN standards, as updated from time to time, and may be modified as desired to implement the various functions and features described herein.

In the example illustrated in FIG. 1, common services (e.g., billing, guest network allocation, etc.) can be performed in a shared service 111 across the available AZs 106, 107. Typically, these shared services will be implemented within a common virtual private cloud (VPC) operating within the cloud environment. Similarly, shared VPC systems can support business support system (BSS) 112, operational support services (also referred to as operating support system or OSS) 113, development/test/integration features 114, and/or the like across the entire region. A region wide data center (identified as a “national” data center 115 in FIG. 1) could be implemented in a shared VPC across AZs 106, 107, if desired, with subordinate data centers (e.g., “regional” data centers 116, 117) being separated into different VPCs for each of the AZs 106, 107. Additional levels of data centers could be provided, if desired, and/or the different data center functions could be differently organized in any number of equivalent embodiments. The various data centers could provide any number of services such as IP multimedia services (IMS), 5G core services and/or the like.

In the example of FIG. 1, each AZ 106, 107 includes one or more breakout edge data centers (BEDCs) 122, 123 each supporting a local zone (LZ, such as LZ1 or LZ2 in FIG. 1) with one or more cell sites. The BEDCs are ideally organized for very low latency to provide best possible throughput and low latency to the various user equipment operating within the local zone. BEDCs 122, 123 will typically implement one or more CUs 124, 125 in accordance with the O-RAN specifications. BEDCs may also implement user plane functions that handle user data sessions for gaming, streaming and other network services, as desired. Again, any number of BEDCs and other data centers may be implemented using any number of different or shared VPCs in the cloud environment, as desired. The DUs 126 may be provided physically at the cell site 128, 129 or may be remote from the cell site, for example provided by the local zone (e.g., LZ1, LZ2, BEDC 122, 123), or any combination thereof depending on each cell site 128, 129. Accordingly, the DU may comprise physical hardware located at a cell site 128, 129 or remote from a cell site, or may comprise virtualized resources as described above.

As noted above, many of the various network components shown in FIG. 1 can be implemented using software or firmware instructions that are stored in a non-transitory data storage (e.g., a disk drive or solid-state memory) for execution by one or more processors within the VPC. VPCs may provide any number of additional features to support the data handling and analysis functions of the system, including redundancy, scalability, backup, key management, reporting, and/or the like.

In some embodiments, the OSS 113 may comprise or otherwise be in communication with an element management system (EMS) configured to manage the network elements (or components) of the system 100. In some embodiments, the EMS can manage a network component or a group of similar network components, for example configuring, reading alarms, obtaining status and other reported information, or the like for a group of network components. For example, the EMS may implement fault, configuration, accounting, performance, and/or security functions. The EMS may interface with the OSS 113, for example to manage inventory, faults, and configuration. The OSS 113 may interface with one or more EMSs. The EMS may also interface with the various components of the network, for example to manage and/or configure DUs and RUs.

The EMS and OSS 113 therefore support deployment of new services, monitoring performance and faults, and meeting quality of service requirements, among other functions. The EMS and OSS may collectively be referred to herein as the OSS 113. In embodiments without a dedicated EMS, the OSS 113 or other similar management programs may perform the functions described above, which again shall be referred to as OSS 113 herein. In various embodiments, the RUs, DU 126, CU 124, 125, cell site router, and other network 102 components, and the performance analysis system 140, are communicatively coupled (e.g., via hardware or software interface) with the OSS 113, BSS 113, and other virtual network services.

As described above, 5G networks such as network 102 may be continually and rapidly expanding and evolving, and a large number of cell sites may require initial setup and ongoing maintenance. Setting up and maintaining numerous cell sites, as well as the rest of the network 102, may be facilitated by standardizing or otherwise prescribing how the cell sites are to be set up. For example, a particular cell site or type of cell site may have a predetermined configuration including number and model of RUs, cell cite routers (CSRs), antennas, and the like, and may include how such components are to be communicatively coupled. Further, the configuration may assign each RU (e.g., identified by serial number, MAC address, or the like) to a specific sector, spectrum band(s), port connection on the CSR, IP address, and the like. In addition, new regions, markets, and cell clusters may be flexibly implemented and decommissioned based on demand, opportunity, use case, and the like.

Referring still to FIG. 1, an RU may transmit, receive, amplify, and digitize radio frequency signals, and may be integrated with one or more antennas or may be separate from but communicatively coupled with one or more antennas of the cell site. RUs may be implemented with radios, filters, amplifiers and other telecommunications hardware to transmit and receive digital data streams via one or more antennas. Generally, RU hardware includes one or more processors, non-transitory data storage (e.g., a hard drive or solid-state memory) and appropriate interfaces to perform various functions such as those described herein. RUs are physically located on-site with the transmitter/antenna, as appropriate. Conventional 5G networks may make use of any number of wireless cells spread across any geographic area, each supported by an on-site RU. In some embodiments, the cell site comprises one RU per sector, and if the cell site is multi-band then it may comprise one RU per band per sector.

Each RU of a cell site 128, 129 may be associated with a different wireless cell that provides wireless data communications to any number of user devices operating within broadcast range of the cell. For example, a cell site 128, 129 may have antennas arranged to serve three sectors of 120-degree coverage each (e.g., one sector per cell), six sectors of 60 degrees each, or any other suitable arrangement, with each such antenna communicatively coupled with an RU for that sector or cell. Each sector may form separate pie-shaped arcs that, combined, form a circle of 360-degree coverage around the cell site. Each sector may be part of a separate cell (e.g., as is common in a three-sector configuration), or multiple sectors may share the same cell (depending on cell site configuration).

Further, the cell sites 128, 129 can be configured for any combination of spectrum bands. For 5G networks, the low band (LB) spectrum may comprise frequencies less than 1 GHz, the mid band (MB) spectrum may comprise frequencies from 1 GHz to 6 GHz, and the high band (HB) may comprise frequencies from 24 GHz to 40 GHz. For example, some cell sites may operate at a single spectrum band, and some cell sites may operate at multiple bands (“multi-band”) such as LB and MB. The respective RUs and antennas may be configured to support the assigned spectrum band(s).

User devices are often mobile phones or other portable devices that can move between different cells associated with the different RUs and different network nodes (referred to as handover), although 5G networks are also widely expected to support home and office computing, industrial computing, robotics, Internet-of-Things (IoT) and many other devices. Therefore, many configurations (e.g., network hierarchies), operational requirements, performance metrics, and the like may be required. While the example illustrated in FIG. 1 shows just a few cell sites 128, 129 for convenience, a practical implementation will typically have any number of cell sites that can each be individually configured, including the RUs at the cell sites, to provide highly configurable geographic coverage for the network 102.

A CSR may function as a network router at the cell site 128, 129 and may aggregate the cell data traffic from the cell site 128, 129 and transmit the aggregated data to the network 102, for example via the DU 126. The CSR may be communicatively coupled with the one or more RUs and one or more CUs 125 via the CSR ports. The CSR can associate each port with an IP address, MAC address, and other desired information. The network 102, for example the OSS 113, may collect such information. Each DU 126 may support multiple cells or cell sites, and the CSR may be communicatively coupled with one or more DUs 125. The DUs 126 may be located at the cell site or external to the cell site, for example implemented via cloud computing, for example at a local zone.

Such information regarding the identification and organization of the cell sites 128, 129 and other hierarchical information (e.g., arrangement of RU to DU to CU, markets, regions, clusters, etc.) may be referred to herein as static data. By way of example, a region may be a partition of the entire network 102 into roughly geographic regions such as West Coast, East Coast, and so on, although in view of various virtual implementations of the network the various network components may be assigned to a region that is not where they are located. For further example, a market may be a partition of a particular region, and in some embodiments may correspond to an availability zone (though there may be many markets per availability zone in some cases). A market may, for example, by assigned to a particular city. For further example, a RAN cluster may be a partition of a market into a number of cell sites with high coverage overlap and low distance between sites. A city (market) may have multiple RAN clusters serving it.

Other data corresponding to the performance of the various components (e.g., throughput, connections, temperature, power, key performance indicators, etc.), which may change continuously or otherwise, may be referred to herein as performance (PM) data. Performance data and static data may be collectively referred to herein as status data.

The network system 100, for example by the performance analysis system 140 and/or its various subsystems, may obtain the various static and performance data from one or more network data sources 225. The performance analysis system 140 may be provided to collect and ingest (e.g., process) raw or processed status data from one or more of the network data sources 225, which in some embodiments may be accessed by one or more of the subsystems of the performance analysis system 140. The network data sources 225 may include any component of or connected to the network that generates relevant information, for example the CU 124, 125, DU 126, RU, cell site 128, 129, OSS 113, BSS 112, antennas, cloud computing systems operating the various zones, regions, BEDC 123, UE, and the like. The performance analysis system 140 may obtain such information by querying the various network components, by receiving streamed data from the components (e.g., in real-time or near real-time), or by any other suitable methods.

Any number of streaming and/or query-based data sources 225 may be deployed within the network 102. Streaming data may be particularly useful for network 102 components that generate substantial amounts of real-time data (e.g., performance measurements, etc.). For example, DU and CU modules of network 102, in particular, provide substantial amounts of real-time data. Generally speaking, data handled by query-based sources tend to be less reliant upon real-time delivery for status updates or the like. Log data, fault metrics, performance metrics and other types of time-series data may be particularly well-suited for query-type collection.

In some embodiments, the performance analysis system 140 may obtain the various information indirectly, for example via a support system such as the OSS 113, BSS 112, or other data collection/aggregation systems and/or processes. For example, in some embodiments, some or all of the relevant static and performance data may be collected by the network 102 centrally (whether logically or physically central), for example in one or more databases, by the OSS 113, or the like, which may also be considered network data sources 225 from which the performance analysis system 140 may obtain relevant information. In some embodiments, the performance analysis system 140 may obtain status data related to UE devices, for example directly from UE devices and/or derived from communication between the UE devices and the network 102, or otherwise provided by the UE to the network 102. The performance analysis system 140 may obtain relevant status data from other suitable sources internal or external to the network 102.

The performance analysis system 140 may be implemented using suitable computing hardware, such as any sort of processor (μP), memory or other non-transitory data storage and input/output (I/O) interfaces for data communications and/or the like. The performance analysis system 140 may comprise an interface (e.g., I/O) to the network 102, for example via wired or wireless networking, application programming interface (API) calls within a software operating environment, virtualized connections, or the like, by which it can collect the various data from the network 102 as described herein. The performance analysis system 140 may comprise an interface external to the network 102, for example to collect status data relevant to the network 102 but from external to the network 102 (e.g., map data, UE device information, weather information, or the like). In various embodiments, hardware is abstracted by virtual computing resources available from AWS or another cloud computing platform, and various subsystems of the performance analysis system 140 may be implemented in the same or separate virtual computing environments (e.g., same or separate nodes). Implementing the performance analysis system 140 using virtualized hardware allows quick deployment and scaling of the performance analysis system 140 and its various subsystems as needed.

In some embodiments, the performance analysis system 140 may be implemented via program instructions configured to run on a computing device (implemented with conventional hardware, virtualized hardware, and/or cloud-based resources as desired) such as a computer server that queries the monitored components according to any desired time schedule to receive data, queries the monitored components on demand, receives data stream from the monitored components, or the like. The data received by the performance analysis system 140 may be locally cached or otherwise stored in any sort of non-transitory memory (e.g., solid state memory, magnetic or optical memory, cloud-based sources, and/or the like) for subsequent retrieval and processing as desired and as described herein. Each monitored component may be internally configured to write its output/log data to performance analysis system 140, as desired.

The performance analysis system 140 may communicate with the monitored components directly and/or through one or more intermediary components or data sources 225 to obtain the desired data. The performance analysis system 140 may format and/or filter the obtained data as appropriate, and forward and/or store the collected and possibly processed data for reporting and/or any other further processing as desired. In various embodiments, the performance analysis system 140 may receive data in one or more formats, may append source and/or service location (e.g., cell site, sector, spectrum band) information as tags or the like, and may push and/or store the tagged data for further processing, display (e.g., via UI/display 158), alert/notification, or the like Some embodiments may also filter the received data as desired to remove unwanted or unnecessary data that would otherwise consume excess storage or require additional processing. Other embodiments may perform additional monitoring, as needed.

The performance analysis system 140 may also provide reports to human and/or automated reviewers. One or more dashboards may be presented on any display 158, for example comprising a user interface (UI). The display 158, for example via a suitable user interface, may also receive data and requests from a user. Other embodiments could implement the various functions and components described herein in any number of equivalent arrangements.

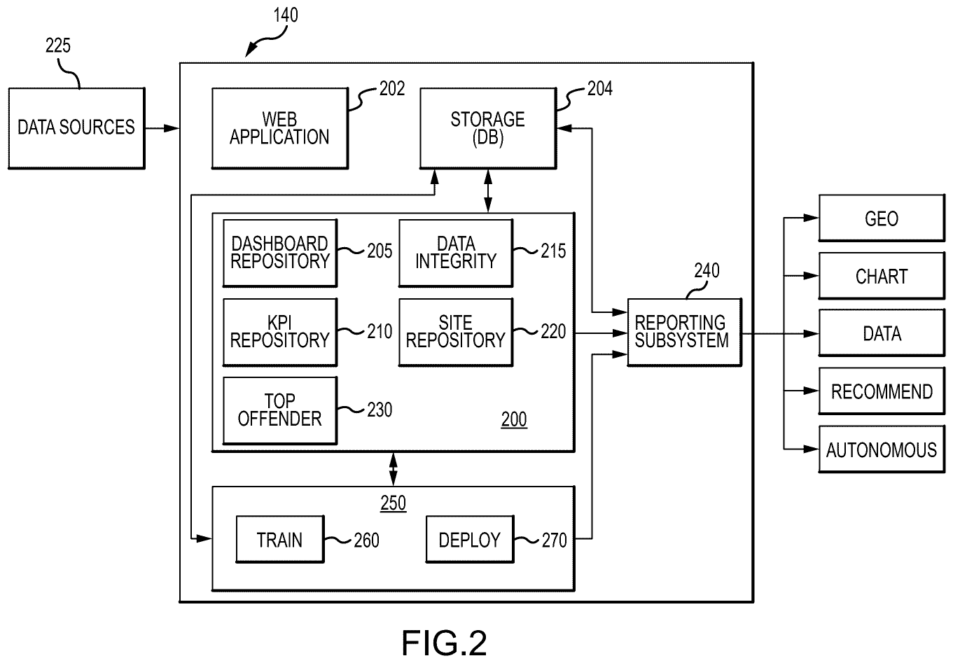

In operation, then, performance analysis system 140 suitably obtains status data from or related to one or more components of a 5G wireless network operating within a cloud-based computing environment. The data can be obtained directly from the component, via intervening data source systems that aggregate data from multiple data sources 225 within the network 102, or the like. Collected data can be tagged, filtered, and/or processed as desired, and the original and/or processed status data is stored in a database for reporting, user, queries, and/or other actions as appropriate. Other embodiments may include other processing modules in addition to those illustrated in FIG. 1 and FIG. 2, and/or may provide the various features and functions described herein using different (but equivalent) arrangements of processing modules and features, as desired.

Referring to FIG. 2, in various embodiments the information (e.g., status data such as performance and static data) obtained by the performance analysis system 140 from the various network data sources 225 (e.g., RUs, DU 126, CU 125, CSR, OSS 113, and/or other network components), is at least temporarily stored in a database 204 or other storage available to the performance analysis system 140 for subsequent processing. The data can also be formatted, as desired, so that data received from different sources can be collectively processed and used in the various subsystems and functions described below. Generally speaking, some embodiments will place received data into a relatively consistent format that can be analyzed and processed by the performance analysis system 140 to permit dashboards, alerts, reports, and recommendations (each of which may be represented in FIG. 1 by the UI/display 158 and/or in FIG. 2 by the web application 202) to be generated by the various subsystems (whether operating alone or together) from different types of data that have been collected about the network 102. The performance analysis system 140, as described in more detail below, may store processed status data in the database 204 or other data storage. In some embodiments, the database 204 may include one or more databases or other data storage of the various subsystems described below.

In various embodiments, the data received from the various network data sources 225 is automatically tagged, by the performance analysis subsystem 140 or its subsystems, or by a network 102 data collection (e.g., OSS 113), with metadata or other information about the data source, the method of collection, dates and/or times of collection, and/or any other information that may be desired. The tagging and metadata may also be considered performance and/or static data, as appropriate. Tagging may be performed by associating the data values with other relevant information within an extensible markup language (XML) structure, a JavaScript object notation (JSON) structure and/or any other format desired. In some embodiments, the initial receiving, formatting, tagging, and/or other processing of the various status data may be performed by an extract, transform, and load (ETL) subsystem of the performance analysis subsystem 140 (not shown).

The performance analysis system 140 may include one or more methods of receiving requests from a user for reports and other output (a “user request”). The user of the performance analysis system 140 may be an individual user associated with the network system 100, another system of the network system 100 (e.g., for automated requests), or the like. The performance analysis system 140 may include a web application interface 202, which may include logic and visualization components configured to accept user web interactions, for example receiving requests and presenting results. The web application interface may be operable via the UI/Display 158. The performance analysis system 140 may also accept user interactions via application programming interfaces (API) (e.g., via software function calls instead of a graphical user interface) from individual users and/or other automated processes.

The performance analysis system 140 is configured to receive the requests and to perform appropriate methods in response to the requests, for example using the various subsystems described below. Reports (graphs, charts, tables, maps, graphics, etc.) and recommendations may be generated in response to requests received via the API, web application 202, or the like, as desired. Reports may be generated for real time presentation to monitor current status of the network 102 and/or its components, for later retrieval/consumption, or the like.

In various embodiments, the performance analysis system (PAS) 140 may comprise a data management (DM) platform 200, a machine learning model (MLM) platform 250, and a reporting subsystem 240. The platforms 200, 250 and the reporting subsystem 240 may comprise the same or different computer systems having hardware and associated computer-executable instructions supporting flexible analysis of information relating to the wireless network and supporting customizable outputs based on the analysis. Thus, in some embodiments, each of the platforms 200, 250 and the reporting subsystem 240 may be implemented as subsystems of the PAS 140. Each of the platforms 200, 250 and reporting subsystem 240 may comprise systems having subsystems implementing various features and functions of the PAS 140.

As with portions of the network 102, the PAS 140 may be implemented via program instructions (computer-executable instructions) configured to run on a computing device implemented with any combination of conventional hardware, virtualized hardware, and/or cloud-based resources as desired. Further, each of the platforms 200, 250, the reporting subsystem 240, and their subsystems may likewise be implemented using virtualized hardware operating within a cloud-type architecture, dedicated hardware, or configured general purpose hardware, among others.

It is often necessary to monitor hundreds or thousands of status data fields, to determine and monitor the operational condition of the network 102 and identify any issues, concerns, suggestions, etc. for the network 102. The vast quantity of data produced by the various network components can be processed by the PAS 140 to generate dashboards, alerts, notifications, recommendations, and/or other reports that may be viewed and interacted with by an operator, autonomously, and the like. The large amount of data can be processed by the systems and subsystems to support user and/or automated queries regarding the status of various aspects or components of the network 102. Status data can also be used to adjust the configuration or operation of the network, as desired. By processing and managing data produced by and/or corresponding to the various components of network 102, then, the status and performance of the network can be monitored, adjusted, improved, and corrected as desired.

Accordingly, the DM platform 200 and MLM platform 250 may comprise data processing subsystems each uniquely configured to retrieve, process, analyze, and act on various network 102 status data to facilitate troubleshooting and improve network performance. The DM platform 200 may comprise a dashboard repository subsystem 205, a KPI repository subsystem 210, a data integrity subsystem 215, a site repository subsystem 220, and a top offender subsystem 230. The MLM platform 250 may also comprise various subsystems, such as a training subsystem 260 and a deployment subsystem 270 uniquely configured to retrieve, process, analyze, and act on the various network 102 status data, for example providing recommended network changes and autonomously implementing such changes as desired.

The data integrity subsystem 215 may analyze the various status data received by the PAS 140 to determine if the status data contains any errors or other inconsistencies that may cause errors or other issues in the further processing, reporting, and recommendations provided by the PAS 140 and its various subsystems and platforms 200, 250. In some embodiments, the data integrity subsystem 215 may analyze patterns of the status data, for example using change detectors, may cross-validate with other data sources to ensure consistency, may perform cross-field validation, may perform duplicate record checks, may perform timestamp and/or temporal validations, may use machine learning models trained on the various types/sources of data, or the like. Upon discovering errant status data, the DM platform 200 may provide a notification or other indication of data integrity to a user or other entity monitoring the PAS 140, for example via a notification subsystem of the DM platform 200. In some embodiments, the data integrity subsystem 215 may provide its results to one or more of the other subsystems of the PAS 140, for example the site subsystem 220. The DM platform 200 may mark (e.g., by tagging), discard, or otherwise note the errant data so that it may be handled properly by the other systems and methods described herein, preventing the use of such errant data and undesired propagation of errors.

For example, as noted above the various components of the network 102 can be implemented using virtual private clouds (VPC) or other virtual hardware components, dedicated hardware, or configured general purpose hardware, among others. More specifically, each of these components will typically produce data during operation that indicates status, identity, performance, capacity, issues and/or any number of other parameters. The many individual network components, for example RUs, antennas, CSRs, DUs, and CUs, may provide status such as identification (e.g., serial number, MAC address, associated cell site, LZ, AZ, market, region, etc.), configuration, performance, capacity, and/or any number of other parameters (collectively, including from the VPCs, referred to herein as status data). Status data may be queried, streamed, or otherwise obtained from the network 102 as discussed above, and may be live data, raw data, formatted or unformatted, or the like, and from a variety of vendors. Status data may further include information required for sleepy cell detection, the output of such sleepy cell detection, key performance indicators (KPI) such as those defined for 5G networks, and the like. The defined KPIs can, for example, be measured at different locations within the network. The data integrity subsystem 215 may be operable to determine the integrity of some or all such data, and provide preventative measure accordingly.

By way of specific examples, in some embodiments, status data may include information provided with health checks (HC) sent by or requested from the RUs, DUs 126, CUs 124, 125, and/or the like. For example, health check information may include specific items such as N3 ping status, pod status, el_ap_status, sctp_status, tx/rx power, flc status, vm status, prach status, cell admin/operational status, and the like. Health check information may be specific to a particular vendor of the relevant equipment and/or operating environment (whether hardware or software), the type or model number of such equipment and/or environment, a particular configuration of such equipment and/or environment, or the like. In some embodiments, status data may include information provided by the CSR (e.g., from an interface status request), by the systems operating the region(s) 104, availability zone(s) AZ1, AZ2, data centers 115, 116, 117, BEDCs 122, 123, local zones LZ1, LZ2, and the like.

The status data may include some KPIs. Such status data may include data specific to a particular network 102 component, may include data corresponding to a group of components (e.g., delay and latency between two or more components, etc.), may include data corresponding to the network as a whole, and the like. KPIs may include a variety of performance indicators, for example latency, jitter, availability, packet loss, area capacity, user data rate, component onboarding, configuration, and deployment times, slice creation time, component scaling time, signal/noise data, and many others. KPIs may include data accessibility and retainability, handover success, rrc connection reestablishment, VONR (Voice Over New Radio) accessibility and retainability, and/or other measures of user experience on the network 102. KPIs may be obtained from a variety of sources, for example depending on the vendor of the particular equipment and/or virtualized operating environment of the network 102, and may correspondingly be in different format or the like. For example, KPIs may be provided by the OSS 113, by a separate tool provided by a vendor of the OSS 113, other system of the network 102, and the like. KPIs may be vendor and/or standard specific.

The status data may include other parameters and various types of electronic documents. For example, status data may include site closeout package documentation corresponding to a completed cell site, including for example floor plans, component settings at time of install, test results from installation, equipment list, serial numbers, software/hardware revisions, power up data, GPS data, antenna setup details, other configuration information, and the like. Documentation may be in any suitable format, for example Portable Document Format, text file, comma-separated value list, HTML, XML, and the like.

The parameters may be separate from the HC, KPIs, and electronic documentation, and may comprise network configurations that tell a UE and a cell site how to behave, when to handover, if the site is not allowed for commercial use, max power, when to do carrier aggregation, when to reselect to a new cell, how long to wait before triggering certain events, where to send random access requests (in terms of frequency and time resources, etc.), and so on. Parameters may be vendor and/or standard specific, and some specific examples of parameters may include rsrp (for example eventa3), hysteresis, qrxlevel Minimum, qRxLevMinOffsetCell, prachPreamble format, timetotrigger (for example eventa3 and a5), sNonintra search threshold (i.e., inter frequency measurement threshold), cell reselection priority, cellbar state, cell reservation state, and so on. There can be thousands of parameters controlling the behavior of a cell site, the network, and the UE.

The site repository subsystem 220 (which may be referred to as a site subsystem) may be configured to (i.e., operable to) obtain static data, for example non-structured network static data like cell site locations, regions, clusters, identifiers, etc., and apply one or more wireless network hierarchies to the obtained static data to create a structured static data in the process of validating the data. Applying the hierarchy allows the obtained static data to be split into appropriate levels. Applying the hierarchy may identify network 102 components at different levels. The validated static data may then be stored by the PAS 140, for example in the database 204 or other data store. Static data that is not validated may be prevented from being stored in the database 204 or otherwise used by the performance analysis system 140 to avoid propagating errors.

The network hierarchy may be any desired partitioning of the network into any suitable number of various related levels. The hierarchy may correspond to the physical arrangement of the network 102 components, for example at different geographic levels. The hierarchy may correspond to a functional split of the network 102 components. The hierarchy may split the network into various network 102 elements which may include a grouping of various network 102 components, for example a cell site element including a specified RU, antenna, CSR, and the like.

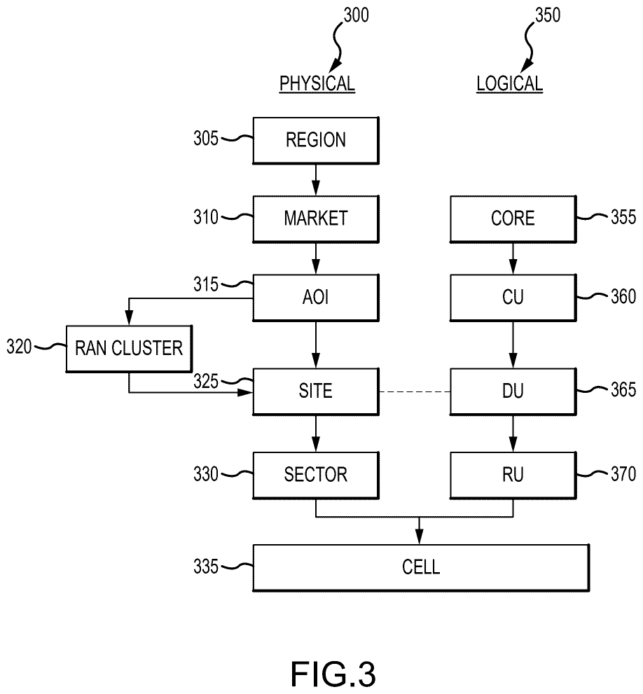

Referring to FIG. 3, in some embodiments, in a physical hierarchy 300, the network may be partitioned from largest to smallest (roughly) geographical region into the levels of region 305, market 310, Area of Interest (AOI) 315, cell site 325, cell 330 sector, and network cell 335. The physical hierarchy 300 may split the network into various network 102 elements which may include a grouping of various network 102 components, for example a cell site element including a specified RU, antenna, CSR, and the like. In some embodiments, the physical hierarchy 300 includes a RAN cluster 320 level (e.g., cluster of cell sites) between the AOI 315 and cell site 325 hierarchy levels.

In some embodiments, in a logical hierarchy 350, the network may be partitioned based on a corresponding network architecture (e.g., O-RAN architecture), for example into Core 355, CU 360, DU 365, RU 370, and cell 335 levels. In some embodiments, one or more levels of the physical hierarchy 300 may correspond to one or more levels of the logical hierarchy 350. For example, in some embodiments, the site physical level 325 may correspond to DU logical level 365, depending on the arrangement of network 102 components. One or more levels of the physical hierarchy 300 may be the same as one or more levels of the logical hierarchy 350. For example, in some embodiments, the cell physical level 335 may equate to the cell logical level 335.

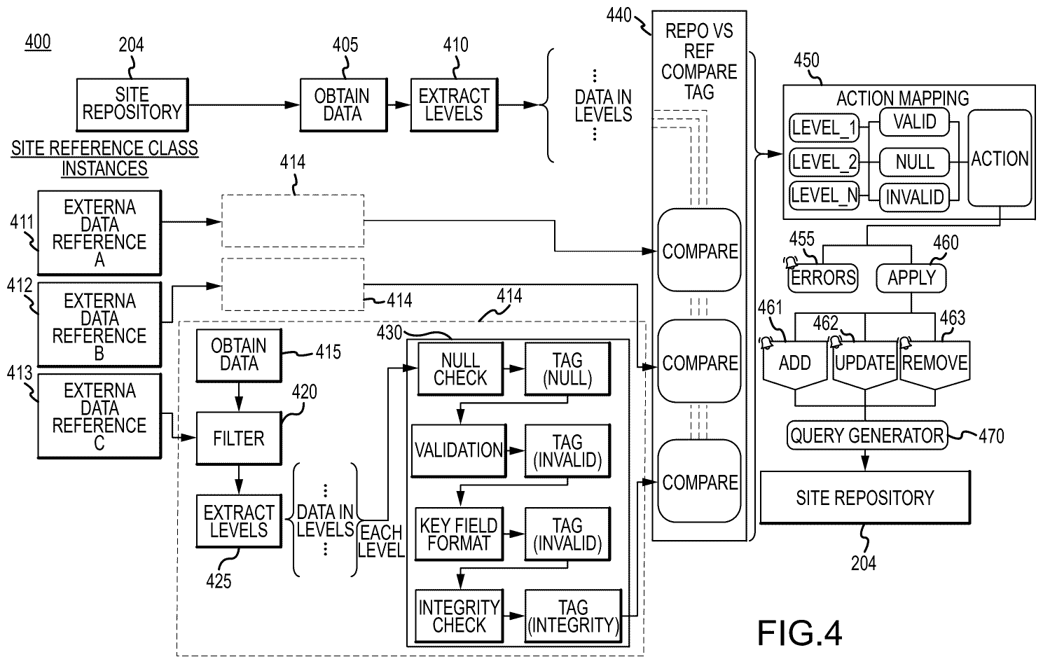

Referring to FIG. 4, the site subsystem 220 may perform a static data validation process 400. The site subsystem 220 may initially receive unvalidated static site data, such as a site's location, region, cluster, identifier, etc., which through process 400 may be appropriately validated (or invalidated) and tagged, among other possible actions. The site subsystem 220 may, at step 405, retrieve the current (e.g., known-good, previously validated, etc.) static data from a site repository which may include a database or other data storage of the PAS 140. In some embodiments, this may include obtaining static data from the database 204. In some embodiments, the site subsystem 220 may maintain a separate site repository where static network data is maintained. Reference to a site repository herein will be understood as a reference to the respective data store(s) managing the respective static site data.

At step 410, the site subsystem 220 may apply one or more desired network hierarchies (e.g., predetermined physical or logical hierarchy) to the retrieved static data from step 405 to extract the static data according to the hierarchy levels. In some embodiments, applying the desired network hierarchy may include organizing and structuring the static data based on the physical and/or logical hierarchy, and/or based on the relationships between the different components of the network. For example, the physical hierarchy may be based on the physical layout or geographical arrangement of the network or the. For further example, the logical hierarchy may be based on the topological arrangement or functional interaction of the network components. After application 220 of the network hierarchy, the obtained static data is structured according to the various hierarchy levels. For example.

The site subsystem 220 may instantiate a site reference class 414 for each of one or more different external static data references 411, 412, 413, for example for each of one or more different network data sources 225. The site subsystem, via the instantiated site reference class 414, may at step 415 obtain new static data from one or more of the external data references 411, 412, 413. The site subsystem 220 may, at step 420, filter the obtained reference static data, for example to remove extraneous information, based on a desired time period, or the like. The site subsystem 220 may also, at step 420, identify and add missing attributes to the obtained reference static data, for example pulling relevant information from other sources, filling in missing information based on data present in the obtained static data, or the like. In addition, at step 420, the site subsystem may perform any necessary data type conversion of the obtained reference static data.

At step 425, the site subsystem 220 may, similar to step 410, apply one or more desired network hierarchies to the obtained static data from steps 415 and 420 to extract the reference static data according to the hierarchy levels. At step 430, the site subsystem 220 may perform one or more checks of the obtained reference static data at each of the extracted levels to verify and appropriately tag the obtained static data. In some embodiments, the checks at step 430 may establish norms for receiving data (frequency, delay, values, etc.) so that variations may be tracked. In some embodiments, the checks at step 430 may include a null check to determine if the data at that particular level is uninitialized or otherwise null, missing, void, or the like. If so, the site subsystem 200 may tag the data as “null” or an equivalent (or otherwise if not null). The checks at step 430 may include a validation of the data at that particular level, and then tagging the data as valid or invalid accordingly. The validation check may include determining whether the data is within an expected range, is of sufficient type, or the like.

The checks at step 430 may include determining whether key field formatting is correct, and then tagging the data as valid or invalid accordingly. In some embodiments, determining correct key field formatting may include checking the structure and/or consistency of the data fields, for example validating that cell identifiers are of the correct format and range, geographic coordinates are appropriate latitude and longitude, frequency band(s) are within an expected range, verifying that data has the correct number of digits or characters, verifying data is in a correct decimal format, and/or the like. The checks at step 430 may include determining the integrity of the data, which may include performing analysis to determine that the data is trustworthy, may include operating on the data using the data integrity subsystem 215, or the like, and then tagging the data accordingly. In some embodiments, the checks at step 430 may include frequency checks to determine whether the data is being received at expected periods, intervals, times, or the like.

At step 440, the site subsystem 220 may compare, per hierarchy level, the extracted current static data from step 410 to the verified and tagged (step 430) extracted static data from the external references 411, 412, 413, and may tag the extracted static data from the external references 411, 412, 413 according to the result of the comparison. In some embodiments, the comparison 440 may determine whether the two sets of extracted data are the same or are otherwise in agreement, whether there has been a change of a value of one or more of the extracted data, whether the extracted data from the external data references 411, 412, 413 contains new data and/or a lack of previously-present data (e.g., cell site added or removed from the network), or the like. After comparison 440, the external static site data may be determined as validated site data or invalidated site data.

In some embodiments, based on the outcomes of the comparison 440 and tagging 430, the site subsystem 220 may perform various actions based on action mappings. At step 450, the site subsystem 220 may determine one or more actions to perform related to the extracted site data according to an action mapping. For each extracted hierarchy level, the site subsystem may, based on the various tags generated by steps 430 and 440, determine one or more actions to take such as updating, adding, or removing data from the site repository or other database as appropriate, sending alerts, performing no actions, or the like. The action mapping 450 may comprise logic, predetermined outcomes, machine learning models, or the like, and may determine the severity of an error in the extracted site data and accordingly report the error, block it from propagating (e.g., prevent it from being stored with the known-good site data), and the like.

At step 455, the site subsystem 200 may, based on the determine action(s), send an alert or make other notifications regarding any issues with the obtained external static data. At the 460, the site subsystem 220 may determine to perform one or more of the actions determined in step 450, for example adding 461 new static data to the site repository, updating the data 462 in the site repository, and/or removing data 463 from the site repository. Each of these actions may also include a notification or other recordation of the actions to be taken. At step 470, the site subsystem 220 may, in performing the actions 461, 462, 463, generate appropriate data storage commands (e.g., database queries) to enact the determined actions in the site repository.

Referring again to FIG. 2, the KPI repository subsystem 210 (which may be referred to as a KPI subsystem) may be configured to (i.e., operable to) obtain existing KPI counters or data from one or more network 102 sources as described above, which may be in proprietary formats depending on the various component vendors, and convert the obtained KPI to a common format.

The KPI subsystem 210 may be configured to obtain performance data (also known as performance measurement (PM) data) from one or more network 102 data sources 225, obtain related KPI formulas (e.g., algorithms, etc.), and calculate KPI data based on the obtained performance data and the obtained KPI formulas. The converted and/or calculated KPI data may be stored by the PAS 140, for example in the database 204 or other data store. The storage for the KPI data may be referred to herein as a KPI repository.

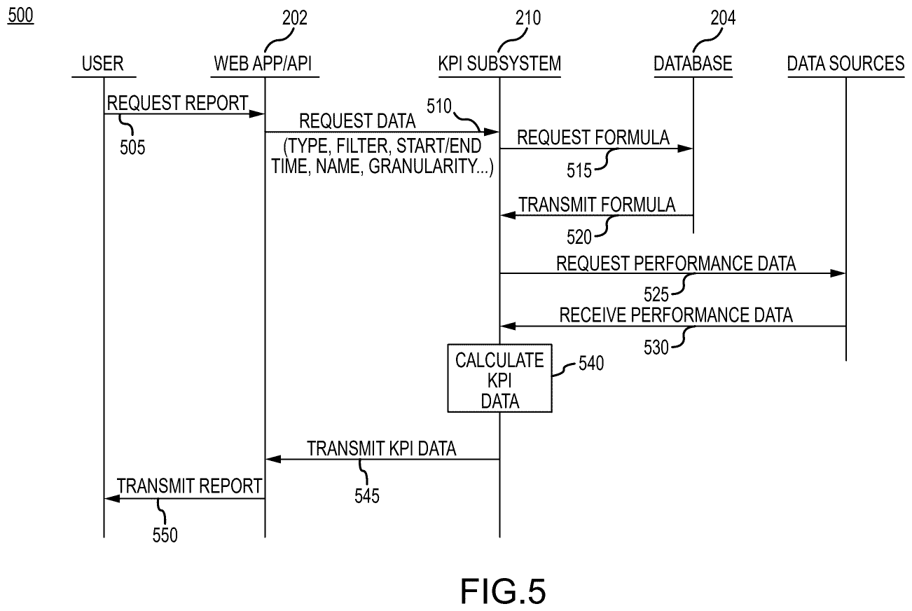

FIG. 5 is a flow diagram illustrating one example of an automated process 500 performed by the KPI subsystem 210 and/or other components of the PAS 140 to provide network KPI data responsive to one or more queries. The various functions, data, formulas, and the like shown in FIG. 5 may be distributed amongst the various components of the network system 100 in any manner, and different embodiments may organize the information collection and processing of various features in any number of different ways. In some examples, the PAS 140 performs broader data collection from various network data sources 225, and the KPI subsystem 210 performs specific data collection, formula retrieval, KPI data calculation, and receiving and responding to requests for KPI data.

Process 500 suitably includes the broad functions of receiving a request for KPI data, obtaining one or more relevant KPI formulas, obtaining relevant PM data, determining the requested KPI data based on the retrieved KPI formula and PM data, and providing the determined KPI to the requestor. In some embodiments, the KPI subsystem 210 may utilize one or more other subsystems of the PAS 140 in determining KPI data, and may send the determined KPI data to one or more other subsystems of the PAS 140, for example a subsystem that made a request for the KPI data.

The PAS 140 may, at step 505, receive a request for KPI data from a user, which may be in the form of a request for a report including or otherwise based on KPI data, a request for formatted or unformatted KPI data, or the like. In various embodiments, the user may be an individual person using the PAS 140, may be another system or subsystem of the PAS 140, may be any suitable system or component of the network 102, or the like. The request may be received 505 by the web application 202, an API of the PAS 140, or the like.

As step 510, the PAS 140 (e.g., web application 202) may send the request for KPI data to the KPI subsystem 210. In some embodiments, the PAS 140 may convert the received request for KPI data 505 to the request to the KPI subsystem 210 by determining what type of KPI is requested or required (e.g., based on a requested 505 report), what filter(s) are to be applied (e.g., geographic region, RU type, network type, etc.), a start time for the data period, an end time for the data period, a KPI name, granularity of the KPI data (e.g., time-based granularity or other aspect), and the like. The PAS 140 may include the type, filter, KPI name, time period, granularity, etc. in the request for KPI data 510. In some embodiments, the KPI subsystem 210 may receive the request 505 and then determine the request for KPI data 510.

The KPI subsystem 210 may obtain one or more KPI formulas (algorithms, calculations, etc.) for determining respective KPI data based on relevant PM data. In some embodiments, the KPI subsystem 210 may locally store the KPI formulas. In some embodiments, the KPI subsystem 210 may, at step 515, request one or more KPI formulas from a data store such as database 204 or other memory of the KPI subsystem 210 or PAS 140. The data store may include a dedicated repository (database, lookup table, spreadsheet, etc.) for KPI formulas, which may be updated from time to time as appropriate. The request may specify details such as the KPI name, granularity, type, and filter, among others. At step 520, the KPI subsystem 210 receives the requested KPI formulas, for example according to the details specified in the request 515.

The KPI subsystem 210 may obtain PM data corresponding to the requested KPI data. In some embodiments, the KPI subsystem 210 may, at step 525, request one or more PM data from one or more network data sources 225 such as individual network components, the database 204, or other memory of the KPI subsystem 210 or PAS 140. The request for PM data 525 may be based on the received KPI data request 510, the identified KPI, the obtained KPI formula (e.g., based on data required by the obtained formulas), and the like. At step 530, the KPI subsystem 210 receives the requested PM data, for example according to the details specified in the request 525.

At step 540, the KPI subsystem 210 may determine the KPI data according to the obtained KPI formula and obtained PM data. In some embodiments, the KPI subsystem 210 may apply the obtained formula(s) to the obtained PM data, for example performing/executing the formula using the PM data, and may apply the identified start and end times, filters, and the like as appropriate. At step 545, the KPI subsystem 210 may transmit the determined KPI data, for example to the originator of the request for KPI data 510. The KPI subsystem 210 may, as appropriate, send the determined KPI data to the web application 202, the API, or the like. The KPI subsystem 210 may, alternatively or additionally, store the determined KPI in a KPI repository associated with the KPI subsystem 210. The KPI subsystem 210 may further format the determined KPI data prior to transmitting the determined KPI data 545. At step 550, the PAS 140 may present or otherwise send the determined KPI data, for example by presenting it on a display to a user, sending it to another subsystem of the PAS 140 or network 102 (e.g., the dashboard subsystem 205, the top offender subsystem 230, etc. of DM platform 200, and/or MLM platform 250), storing it in a database such as database 204 for later retrieval, and the like.

Referring again to FIG. 2, the top offender subsystem 230 determines an amount of negative effect caused by each of an identified set of network 102 elements or components, and ranks each of the network elements/components accordingly to provide an indication of which are having the largest negative impact on network 102 performance. The amount may be absolute, relative to other network 102 elements/components (referred to hereafter just as elements for brevity), or any other suitable measure of effect. In some embodiments, the top offender subsystem 230 may be configured to (i.e., operable to) determine and present information indicating which elements of the network 102 (e.g., by components, hierarchy levels, or the like) have the worst (e.g., most negative) effect on the performance of the network 102. The top offender subsystem 230 may obtain and subsequently analyze relevant information from one or more of the other subsystems of the PAS 140, such as the site subsystem 220 and the KPI subsystem 210, and may rank relevant network elements (e.g., cell sites) based on the magnitude or other measurement of the effect of each element on the performance of the network 102.

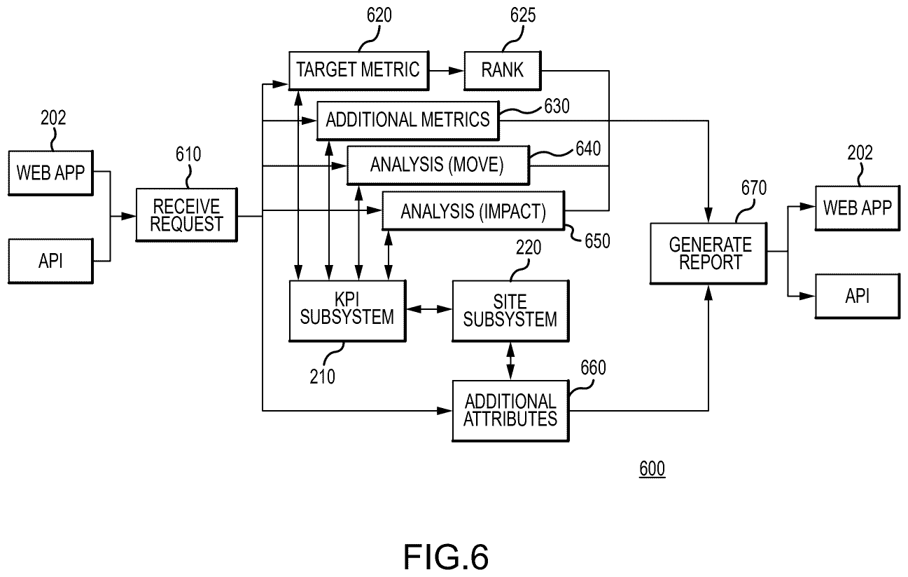

Referring to FIG. 6, the top offender subsystem 230 may perform an automated process 600 to identify the performance impact of various network 102 elements and may identify the worst offenders. In some embodiments, the top offender subsystem 230 may, at step 610, receive a request for a top offender list based on specified parameters, such as target metric, hierarchy level, filters (e.g., excluding specific sites known to cause issues, known to be consistently poor performers, etc.), granularity (e.g., hourly, daily, etc.), source, vendor, or the like. The target metric may be a specified measure of network performance, and may be the primary metric on which to rank the network elements. The target metric may comprise any suitable type of metric such as number of fails, percentages, counts, or the like. The target metric may comprise a KPI. In some embodiments, the top offender subsystem 230 may receive the request via a user interface (e.g., via the web application 202), via API, or the like.

The top offender subsystem 230 may, at step 620, obtain (e.g., request and receive) an indication of performance corresponding to the target metric, identified network elements, and other parameters specified by the request. In some embodiments, step 620 may include requesting KPI data corresponding to the target metric and other parameters from the KPI subsystem 210, for example as described with respect to FIG. 5. The top offender subsystem 230 may provide the required parameters, such as granularity, KPI name, type/KPI family, filters, etc., to the KPI subsystem 210 based on the received request 610. In some embodiments, step 620 may include obtaining PM data corresponding to the target metric from one or more network data sources 225 and then determining the target metric accordingly.

In some embodiments, at step 620, the top offender subsystem 230 may request static data from the site subsystem 220 corresponding to the received request 610, for example to determine the group of network 102 elements (e.g., an identifier of the group of network elements which may be an identifier of the group or an identifier of each element in the group) to analyze for ranking. For example, at the cell site level, the top offender subsystem 230 may interact with the site subsystem 220 to determine all cell sites within a specified region, market, etc. (based on the request 610), and then may accordingly request respective KPI data from the KPI subsystem 210. In some embodiments, the request for KPI data 620 may cause the KPI subsystem 210 to interact with the site subsystem 220 to determine the appropriate network 102 components and elements to analyze, and then provide corresponding KPI data to the top offender subsystem 230.

At step 625, the top offender subsystem 230 may determine a rank for each respective network 102 element based on the received KPI data from the KPI subsystem 210, based on the determined target metric, or the like from step 620. The determined rank comprises an ordering, for example from worst to best network 102 element where the worst network element is the one having the most negative effect on network 102 performance (or a subset of the network 102, depending on filters and other parameters of the request 610) according to the specified target metric. Rank can be an indication of absolute or relative placement on a scale of worst to best, may be on the range of the entire network 102 even if only subset of the network 102 is requested, or any other suitable implementation of a ranking.

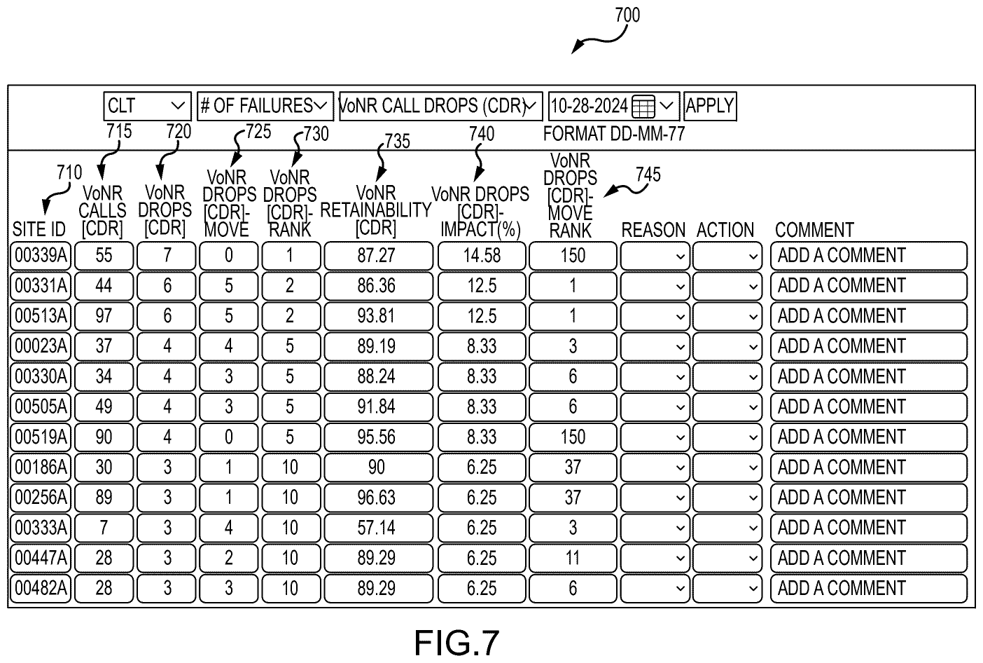

For example, briefly referring to FIG. 7, according to an exemplary request 610 for the top offender with respect to dropped calls (voice over new radio or “VoNR” drops) in a specified RAN cluster, market, or the like, the top offender subsystem 230 may rank the cell site having the most dropped calls as the worst (e.g., a rank of “1”), and may rank the other cell sites of the RAN cluster respectively. The top offender subsystem 230 may output the respective network 102 elements, such as identified cell sites 710, the determined rank 730 for the respective elements, and may output the actual metric 720 (e.g., number of dropped calls). In some embodiments, the KPI subsystem may be configured to receive user requests for top offender reports via a configuration screen, for example operable via the web application 202, allowing a user to select a data source, vendor, hierarchy level, granularity (hourly, etc.), KPI family, KPI name, and/or any other suitable attributes.

Still referring to FIGS. 6 and 7, the top offender subsystem may, at step 630, determine additional metrics that are not part of the target metric but may be otherwise related to the target metric. The additional metrics may be chosen to add context to the target metric for each network element and/or the assigned ranking 625. The additional metrics may include obtained KPI from the KPI subsystem 210, metrics determined by any suitable subsystem including the top offender subsystem 230, and the like. For example, for a target metric of dropped calls, the top offender subsystem 230 may obtain the additional metrics of number of calls 715 and call retainability 735. In some embodiments, the top offender subsystem 230 may further determine a rank for each respective network element 745 based on the determined additional metrics.

The top offender subsystem 230 may, at step 640, determine a moving analysis of the target metric. The moving analysis 640 may indicate the movement of the target metric and/or additional metrics over a certain time period, for example the recent change in the target metric, and may include whether it is getting better or worse and by how much. The moving analysis may facilitate determination of whether a particular network 102 element is a new top offender or an upcoming issue, a problematic network element that is historically problematic, a problematic network element that has a resolved issue and is improving, or the like. For example, for a target metric of dropped calls, the top offender subsystem 230 may determine the movement (e.g., positive increase) in dropped calls 725 over a certain time period, such as the past day. In some embodiments, the top offender subsystem 230 may further determine a rank for each respective network element 745 based on the determined moving analysis. For example, a network element having the greatest increase in dropped calls may be given a rank of “1,” and so on.

The top offender subsystem 230 may, at step 650, determine an impact analysis of the target metric and/or additional metrics. The impact analysis 640 may indicate the relative or absolute impact of the target metric over a certain time period, for example with reference to the other network elements. The impact may be with respect to a specified hierarchy level, for example site level, region level, city level, etc.). The impact analysis 650 may include an indication of how much a particular network 102 element is affecting the performance with respect to the target metric compared to the remainder of the network elements. The impact analysis 650 may facilitate determination of the relative severity of the performance issue of the network element. For example, for a target metric of dropped calls, the top offender subsystem 230 may determine the impact (e.g., percentage of total) of dropped calls 740 over a certain time period, such as for a particular day, week, month, or the like. In some embodiments, the top offender subsystem 230 may further determine a rank for each respective network 102 element based on the determined impact analysis.

The top offender subsystem 230 may, at step 660, determine additional attributes to include in a response to the originator of the request 610, for example in an output report, which in some embodiments may provide additional context to the analyzed PM data. The additional attributes may include attributes which are determined to help troubleshoot the cause of the performance issues of the respective network 102 elements, and may be obtained from the site subsystem 220 in some exemplary embodiments. For example, if the target metric is at the cell site hierarchy level, the top offender subsystem 230 may include the additional attributes of the cell site names 710, cell site power levels, other status data that corresponds/contributes to the target metric, and/or other relevant cell parameters.

At step 670, the top offender subsystem 230 may generate and provide an output in response to the request 610. In some embodiments, step 670 may include determining an output report, generating a dashboard, providing formatted data, or the like based on the determined target metric 620 and/or rank 625, additional metrics 630, moving 640 and impact 650 analysis, and/or additional attributes 660 as desired. FIG. 7 illustrates an exemplary output top offender report 700 based on a request for a cell site-level (CLT) top offender report for a target metric of dropped calls on a specified date. The generated output response may be provided, for presentation to a user, to the web application 202, API, or the like as appropriate, based on the originator of the request 610. In some embodiments, the generated output response may be stored, for example in database 204, for later use by the PAS 140 and/or a user thereof.

Referring again to FIG. 2, in some embodiments, the dashboard subsystem 205 may be in communication with the site subsystem 220, KPI subsystem 210, and top offender subsystem 230. The dashboard subsystem 205 may be configured to (i.e., operable to) automatically generate predefined dashboards and to generate dashboards according to a received user request (e.g., via web application 202). The dashboard subsystem 205 may create user requests, for example in response to the received user request, and may send the user requests to one or more of the subsystems 210, 220, 230 to obtain relevant data and generate dashboards. In some embodiments, the dashboard subsystem 205 may generate the dashboards according to predetermined dashboard configurations. In some embodiments, the dashboard subsystem 205 may generate the dashboards according to a predetermined schedule, based on a trigger or other predetermined criteria, and the like. The dashboard subsystem 205 may store the generated dashboards for later use, for example in database 204, may provide the generated dashboard to a requester of the dashboard, or the like. The dashboard subsystem 205 may provide one or more dashboards to the reporting subsystem 240.

Referring still to FIG. 2, the MLM platform 250 may be configured to select one or more MLMs according to a received request such as a user request, a scheduled job (e.g., scheduled analysis of network conditions), a trigger (alarm, alert, predetermined condition, etc.), or the like, and may determine a recommended network change and/or autonomously implement the determined recommended change on the network 102. As described above, the MLM platform 250 may include a training subsystem 260 and a deployment subsystem 270 implementing one or more machine learning models (MLMs), each for example trained based on a machine learning algorithm, to perform status data embedding and embedding of user queries, to understand user queries, to format and generate responses, to determine recommended network changes, or the like. A ML algorithm may comprise a procedure run on a training data set to create a ML model, and a ML model may be configured to receive new input data and generate an estimation, prediction, classification, response, vector, or the like for the new input data. An ML model may also be referred to as an AI (artificial intelligence) model.

The MLM platform 250, which may include multiple MLMs and may be configured to use the MLMs in connection with each other and/or supporting processes, may be stored in the memory of the PAS 140. The supporting processes may include, for example, automated routines to perform functions that facilitate providing input to and managing output from a MLM, including filtering, formatting, database 204 access, or the like. Some supporting processes may select appropriate MLMs based on the received request, and may determine appropriate tasks/output. The MLM platform 250 (e.g., a processor of the PAS 140 or MLM platform 250) may execute operating routines including the MLMs, and may generate actions and output based on one or more of the obtained status data, user queries, or the like. In some embodiments, the MLMs may comprise suitable ML models for creating vector embeddings from input data/queries (an embedding model), language models for understanding queries and formatting responses, or the like.

The ML algorithm(s) for the ML models discussed herein may be implemented on any suitable computing system. In some embodiments, the training subsystem 260 may be configured to perform the ML algorithm. The ML algorithm may be configured to construct and/or retrain a MLM based on the training data set. In some embodiments, multiple MLMs may be trained according to multiple data sets, each corresponding to different network troubleshooting requirements, resulting in a library or catalogue of MLMs that can be used to make predictions for a variety of possible troubleshooting needs. The training data set may comprise example inputs and their actual outputs (e.g., vector embedding, query and expected response, etc.). Some generated MLMs can map the inputs to the outputs based on the provided training set. The MLMs may be updated over time, for example as the training data set becomes larger, is improved, as the number of user queries and responses increases (e.g., with corresponding feedback), or is otherwise updated. As the network 102 evolves, the MLMs of the MLM platform 250 may be retrained from time to time by the training subsystem 260 to increase accuracy of the generated responses, to alter response format, or the like.

The ML algorithms may be configured to perform machine learning using various methods, such as decision tree learning, associates rule learning, artificial neural networks, deep learning, convolutional neural networks, recurrent artificial neural networks, long short term memory neural networks, inductive logic programming, support vector machines, clustering, random forest, Bayesian networks, reinforcement learning, supervised/unsupervised learning, representation learning, similarity and metric learning, sparse dictionary learning, genetic algorithms, k-nearest neighbor (KNN), among others.

As described above, the one or more ML algorithms are configured to perform a particular task, for example training a MLM to create a vector embedding for obtained status data and/or a user query (for retrieving closest results), determine a human-like/readable response to a user query based on retrieved data from the database, determine a network change according to validated site data and KPI data, and the like. The tasks for which the MLMs are trained may vary based on, for example, the type of network 102, the number and type of network components, the anticipated amount of status data, tradeoffs between accuracy and speed in determining output, and so on.

The MLM platform 250 may include any suitable MLMs to process large quantities of past (historical) and/or present status data and identify (classify, categorize, etc.) patterns in the data. In some embodiments, the MLM system may include a large language model (LLM) that can perform natural language processing tasks such as summarizing data and text and answering user queries by generating a natural language response. In some embodiments, the MLM system may include an embedding model (EM) that converts status data (in its various forms) and user queries into a numerical representation of the status data, for example vector(s) of numbers reflecting its semantic meaning and creating a unique identifier for a particular obtained status data. Exemplary embedding models may assign such identifiers to any type of status data, whether text, numerical data points, image, or the like. Embedding models may support a semantic search of the status data. The distance between vectors of status data and/or queries can measure the relationship between the various data and/or queries, and a similarity search may be performed on the vector store to find the closest results to an embedded (e.g., vectorized) query, for example.

The deployment subsystem 270 may be configured to select one or more MLMs from the MLM catalogue based on the received request for analysis, trigger, or the like. The deployment subsystem 270 may obtain corresponding PM data and/or site data according to the request, for example validated site data from the site subsystem 210 and KPI data from the KPI subsystem 210. The deployment subsystem 270 may execute the selected MLM(s) using the obtained status data. The deployment system may be configured to perform a predetermined task based on the output of the MLM, for example providing a recommended action such as a change to the network 102 (configuration change, parameter change, capacity restrictions, change neighbor relation, change tilt, change traffic balance, etc.), implementing the recommended change, providing a notification, or the like. The predetermined tasks may be selected from a plurality of predetermined tasks (e.g., a library or catalogue of tasks), each of which may be tailored for a particular troubleshooting use case. In some embodiments, the determined action recommendation may be provided to the requestor, to another user of the network system 100, or otherwise to one or more systems of the network 102, for example via the API, via the web application 202, or the like.

Referring still to FIG. 2, in some embodiments, the reporting subsystem 240 may be configured to provide a network performance report in response to a user request. In some embodiments, the reporting subsystem 240 may further be configured to provide a recommended action such as a change to the network 102, automatically implement a network 102 change, and the like. In some embodiments, the reporting subsystem 240 may be in communication with the DM platform 200 and MLM platform 250, and may be in communication with respective data storage such as database 204. The reporting subsystem 240 may be configured to generate the necessary requests to the various subsystems of the PAS 140 to generate the response to the user request. The reporting subsystem 240 may be configured to automatically generate the network performance report, recommended actions, and the like according to a received user request (e.g., via web application 202), according to a predetermined schedule, based on a trigger or other predetermined criteria, and the like. The reporting subsystem 240 may store the generated network performance reports, recommended action, etc., for later use, for example in database 204, may provide the reports and recommendations in response to the user request, or the like.

The network performance reports summarize PM data and other data, in some cases according to the network hierarchy indicated by the user request. The network performance reports may include geographical reports, chart reports, and data reports. The geographical reports may present geographically-oriented data in any suitable manner. For example, the geographical reports may include cell, sector, site, and cluster visualization, may include handoff-related statistics and relations (i.e., when a UE is moved from one cell site to another nearby cell site), may include information related to low-traffic cells, and the like. The chart reports may include graphical representation of KPI data, rank, move, and impact metrics, a multi-level top offender report, other graphed KPI's, and the like. The reporting subsystem 240 may obtain chart reports from the dashboard subsystem 205. The data reports may include raw or formatted data, for example generated or otherwise obtained from the KPI subsystem 210, site subsystem 220, top offender subsystem 230, database 204, and/or the like, and may be provided in some cases via API and/or stored for later retrieval.

The recommended action, automated implementation of the recommended action, and the like may be performed based on the output of the MLM subsystem 250 as described above. The reporting subsystem 240 may be configured to obtain one or more recommended actions from the MLM subsystem 250 by generating appropriate request(s) to the MLM subsystem 250 in response to the user request. The reporting subsystem 240 may be further configured to implement, notify, or otherwise report the recommendations. In some cases, the implementation of the recommended actions may be performed by another system of the network system 100.

In some embodiments, then, the PAS 140 may receive a user request via a user interface such as the web application 202, API, or the like. The PAS 140, for example via the reporting subsystem 240, may cause the site subsystem 220, KPI subsystem 210, and/or top offender subsystem 230, as appropriate to the user request, to obtain and process static data and performance data (respectively) according to the user request. In some embodiments, the PAS 140, for example via the reporting subsystem 240, may obtain the appropriate validated site data and KPI data from memory such as database 204, for example when it has been previously processed by the respective subsystems 220, 210. The PAS 140, for example via the reporting subsystem 240, may generate one or more network performance reports based on the received user request. The PAS 140 may provide the generated performance report(s) to the requestor via the user interface, for example via the web application 202, API, or the like. In some embodiments, the network performance report may comprise a top offender analysis generated by the top offender subsystem 230. In some embodiments, the PAS 140 may provide, according to the user request, a recommended action and/or implementation of the recommended action according to deployment of one or more MLMs of the MLM subsystem 250.

Various embodiments therefore provide a performance analysis system that can obtain, aggregate, and validate status data (in a variety of formats) regarding numerous aspects of a network 102 and its various components, process the data according to a data management subsystem and MLM system, and generate appropriate and accurate reports and recommendations to facilitate in troubleshooting performance aspects of the network 102. Various embodiments advantageously provide common interface(s) to access validated and performance-analyzed status data to facilitate troubleshooting.

In contrast to prior methods of troubleshooting involving separate review of status data by different groups of people for different respective problem-solving needs, systems and methods as described herein permit much more sophisticated, connected, and flexible analysis, reporting, and recommendation than was previously available for such wireless networks. This allows for a complete understanding of network status, thereby improving identification and correction/prevention of issues, network functionality, and the like. Systems and methods as described herein allow performance impact analysis of a wide variety of relevant information not previously manageable for a 5G network, leading to quicker and more efficient and effective problem solving, resolution, mitigation, and performance improvement. Other embodiments may provide additional benefits and features, as desired.

The various functions shown in the several process flows may be distributed amongst the various components of system 100 in any manner, and different embodiments may organize the processing of various features in any number of different ways. Each of the various features and systems described herein may be implemented in software and/or firmware that resides in non-transitory data storage for execution by one or more processors to perform the various automated processes described herein.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A performance analysis system associated with a wireless network having a plurality of cell sites, the performance analysis system having a processor and an interface to the wireless network and comprising:
a user interface configured to receive a user request for a network performance report;
a data management subsystem configured to obtain, via the network interface and from one or more network data sources, a performance data and a static data, wherein the data management subsystem comprises:
a site subsystem configured to analyze, using the processor, the obtained static data to generate a validated site data; and
a key performance indicator (KPI) subsystem configured to apply, using the processor, a KPI formula to the obtained performance data to generate a KPI data; and
a reporting subsystem configured to:
generate, by the processor and according to the received user request, the network performance report based on the validated site data and the KPI data; and
provide, via the user interface, the generated network performance report.

2. The performance analysis system of claim 1, wherein the site subsystem is configured to analyze the obtained static data according to a network hierarchy.

3. The performance analysis system of claim 2, wherein the network hierarchy comprises at least one selected from the group of a logical hierarchy and a physical hierarchy.

4. The performance analysis system of claim 1, wherein the KPI subsystem is configured to obtain the KPI formula from a KPI formula repository based on the user request.

5. The performance analysis system of claim 1, wherein:
the network performance report summarizes the KPI data according to a network hierarchy indicated by the user request.

6. The performance analysis system of claim 1, further comprising a dashboard subsystem configured to:
obtain the validated site data from the site subsystem;
obtain the KPI data from the KPI subsystem;
generate a predetermined dashboard based on the obtained validated site data and KPI data; and
store the generated predetermined dashboard in a database for later presentation via the user interface.

7. The performance analysis system of claim 1, further comprising a machine learning model (MLM) subsystem configured to:
obtain the KPI data and the validated site data;
process, by a MLM of the MLM subsystem and using the processor, the obtained KPI data and validated site data to generate a recommended action; and
provide the recommended action via the user interface.

8. The performance analysis system of claim 7, wherein the MLM subsystem is further configured to automatically perform the recommended action on the wireless network.

9. The performance analysis system of claim 7, wherein the MLM subsystem is configured to retrieve the MLM from a catalogue of MLMs based on the user request.

10. The performance analysis system of claim 1, further comprising a data integrity subsystem configured to:
analyze the obtained performance data and static data to identify erroneous performance data and erroneous static data; and
prevent identified erroneous performance data and erroneous static data from being used in the generation of the network performance report.

11. An automated process performed by a performance analysis system associated with a wireless network having a plurality of cell sites, the performance analysis system comprising a processor and an interface to the wireless network, the automated process comprising:
receiving a user request for a network performance report via a user interface of the performance analysis system;
obtaining, by a data management subsystem of the performance analysis system, a performance data and a static data from one or more network data sources via the network interface;
analyzing, by a site subsystem of the data management subsystem, the obtained static data to generate a validated site data;
applying, by a key performance indicator (KPI) subsystem of the data management subsystem, a KPI formula to the obtained performance data to generate a KPI data;
obtaining, by a reporting subsystem and from the site subsystem, the validated site data in response to the user request;
obtaining, by the reporting subsystem and from the KPI subsystem, the KPI data in response to the user request; and
generating, by the reporting subsystem, the network performance report based on the obtained validated site data and obtained KPI data.

12. The automated process of claim 11, wherein the site subsystem analyzes the obtained static data according to a network hierarchy.

13. The automated process of claim 12, wherein the network hierarchy comprises at least one selected from the group of a logical hierarchy and a physical hierarchy.

14. The automated process of claim 11, further comprising obtaining, by the KPI subsystem, the KPI formula from a KPI formula repository based on the user request.

15. The automated process of claim 11, wherein generating the network performance report comprises summarizing the KPI data according to a network hierarchy indicated by the user request.

16. The automated process of claim 11, further comprising:
obtaining, by a dashboard subsystem, the validated site data from the site subsystem;
obtaining, by the dashboard subsystem, the KPI data from the KPI subsystem;
generating, by the dashboard subsystem, a predetermined dashboard based on the obtained validated site data and KPI data; and
storing, by the dashboard subsystem, the generated predetermined dashboard in a database for later presentation via the user interface.

17. The automated process of claim 11, further comprising:
obtaining, by a machine learning model (MLM) subsystem, the KPI data and the validated site data;
processing, by a MLM of the MLM subsystem, the obtained KPI data and validated site data to generate a recommended action; and
providing the recommended action via the user interface.

18. The automated process of claim 17, further comprising automatically performing the recommended action on the wireless network.

19. The automated process of claim 17, further comprising retrieving, by the MLM subsystem, the MLM from a catalogue of MLMs based on the user request.

20. The automated process of claim 11, further comprising:
analyzing, by a data integrity subsystem, the obtained performance data and static data to identify erroneous performance data and erroneous static data; and
preventing, by the data integrity subsystem, identified erroneous performance data and erroneous static data from being used in the generation of the network performance report.
